(19) United States
(12) Patent Application Publication
(10) Pub. No.: US 2014/0030930 A1
(43) Pub. Date: Jan. 30, 2014

(54) ELECTRICAL CONNECTOR

(71) Applicant: DUONG PHAN, City of Westminister, CA (US)

(72) Inventor: DUONG PHAN, City of Westminister, CA (US)

(73) Assignee: HON HAI PRECISION INDUSTRY CO., LTD., New Taipei (TW)

(21) Appl. No.: 13/558,302

(22) Filed: Jul. 25, 2012

(51) Int. Cl. H01R 24/00

(52) U.S. Cl. 439/660

(57) ABSTRACT

An electrical connector (100) includes an insulative housing (1) and a plurality of contacts (2) received in the insulative housing (1). The contacts (2) include a plurality of first and second contacts (21, 22) and a grounding contact (23). The first contact (21) has a first retaining portion (213) and a first soldering portion (215); the second contact (22) has a second retaining portion (223) and a second soldering portion (225); the grounding contact (23) has a third retaining portion (233) and a third soldering portion (235). The third soldering portion (235) is disposed in a board shape and separates the first soldering portion (215) from the second soldering portion (225) along an upper to lower direction to improve signal transmission quality of the electrical connector (100).

### BACKGROUND OF THE INVENTION

1. Field of the invention

The present invention generally relates to an electrical connector and more particularly to an electrical connector having a grounding contact.

2. Description of Related Art

U.S. Pat. No. 7,425,155 discloses an electrical connector including an insulative housing, a plurality of contacts retained in the insulative housing and a metal shell covering the insulative housing. The isnulative housing includes a body portion and a mating portion extending forwardly from the body portion. The contacts comprises a pair of the first contacts, a pair of the second contacts and a third contact located in a same side of the first and second contacts. Each contact includes a retaining portion retained in the insulative housing, a contacting portion received in the mating potion and a soldering portion extending backwardly from the retaining portion and out of the insulative housing. The soldering portions of the contacts are adjacent with each other that may influence the signal transmission quality of the electrical connector.

Other objects, advantages and novel features of the present invention will become more apparent from the following detailed description of the present embodiment when taken in conjunction with the accompanying drawings.

### SUMMARY OF THE INVENTION

The present invention provides an electrical connector comprises an insulative housing a body portion, a plurality of contacts retained in the insulative housing. The contacts comprises a pair of first contacts, a pair of second contacts and a grounding contact located between the first and second contacts. The first contacts each includes a first retaining portion retained in the insulative housing and a first soldering portion located in the rear of the retaining portion. The second contacts each includes a second retaining portion retained in the insulative housing and a second soldering portion located in a rear of the retaining portion. The grounding includes a third retraining portion retained in the insulative housing and a third soldering portion extending backwardly from the retaining portion. The first soldering portion is located below the third soldering portion and the third soldering portion is located below the second soldering portion. The third soldering portion is disposed in a horizontally board shape which separate the first soldering portion from the second soldering portion along an up-to-down direction.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector according to a preferred embodiment of the present invention;

FIG. 2 is an exploded, perspective view of the electrical connector as shown in FIG. 1;

FIG. 3 is another exploded view of the electrical connector similar with FIG. 2;

FIG. 4 is a partially assembled view of the electrical connector as shown in FIG. 1;

FIG. 5 is similar with FIG. 4;

FIG. 6 is a perspective view of a plurality of contacts of the electrical connector according to a preferred embodiment of the present invention.

### DETAILED DESCRIPTION OF THE INVENTION

Reference will now be made to the drawing figures to describe the preferred embodiment of the present invention in detail.

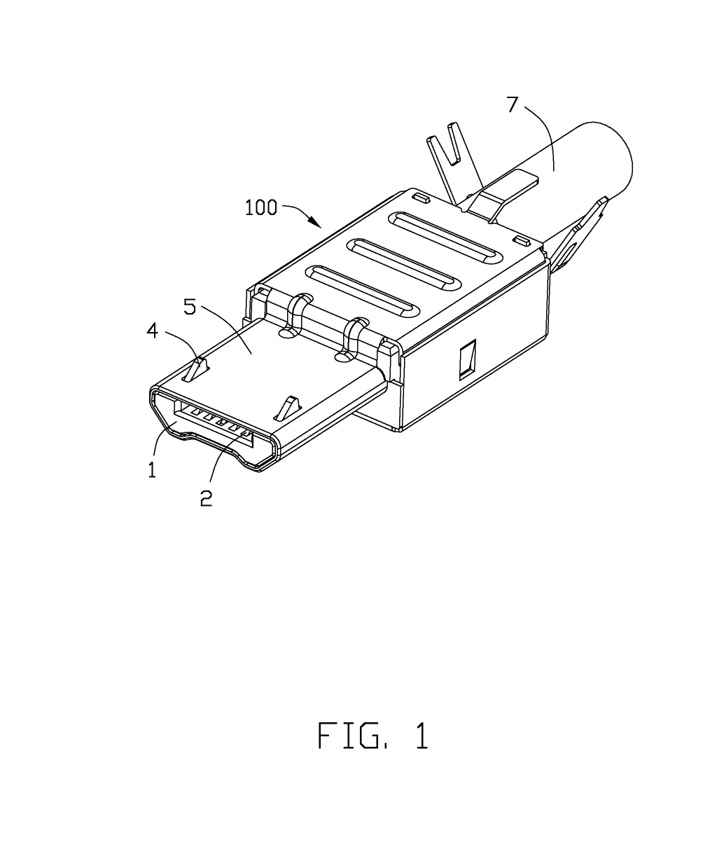

Referring to FIGS. 1-3, an electrical connector in this present invention is a Micro DiiVA (Micro Digital Interactive interface for Video Audio). The electrical connector 100 includes an insulative housing 1, a plurality of contacts 2 retained in the insulative housing 1, a locking member 4 retained in the insulative housing 1, a metal shell 5 covered at the insulative housing 1 and a cable 7 soldering with the contacts 2.

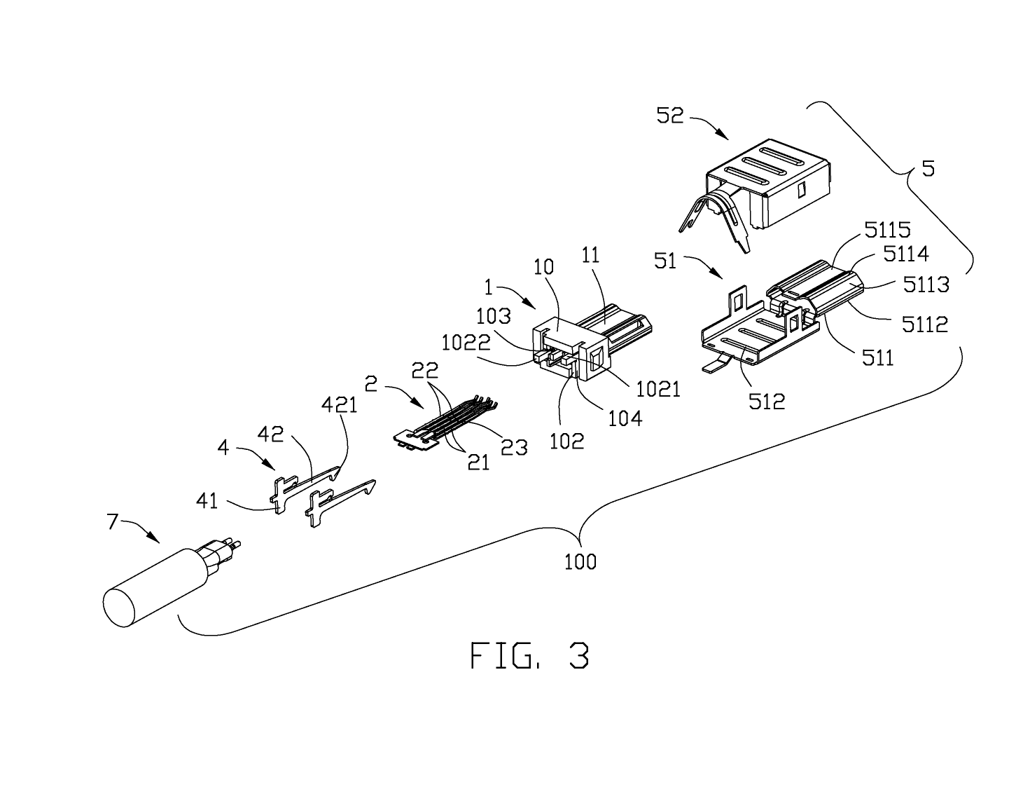

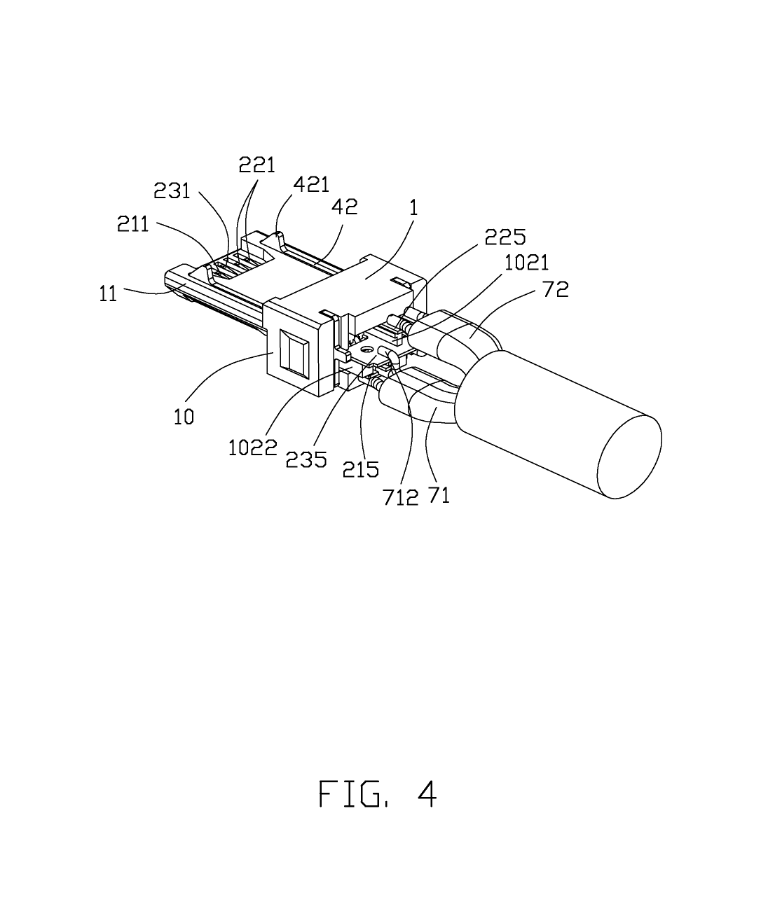

Referring to FIGS. 3-4, the insluative housing 1 includes a rectangular-shaped body portion 10 and a mating portion 11 extending forwardly from the body portion 10. The body portion 10 includes a front wall 101 and a rear wall 102 having a plurality of retaining slots 103 passing backwardly therethrough and two mounting slots 104 located on two sides of the retaining slots 103. The mating portion 11 has an cutout 111 depressed downwardly from a front thereof, a plurality of receiving slots 112 communicated with the retaining slots 103 and arranged in the cutout 111, and two through holes 113 which is located on two sides of the mating portion 11 to receive the locking member 4 therein. The through holes 113 pass backwardly through the mating portion 11 and communicate with the mounting slot 104. The insulative housing 1 has two first ribs 1021 and two second ribs 1022 all extending backwardly from the rear wall 102.

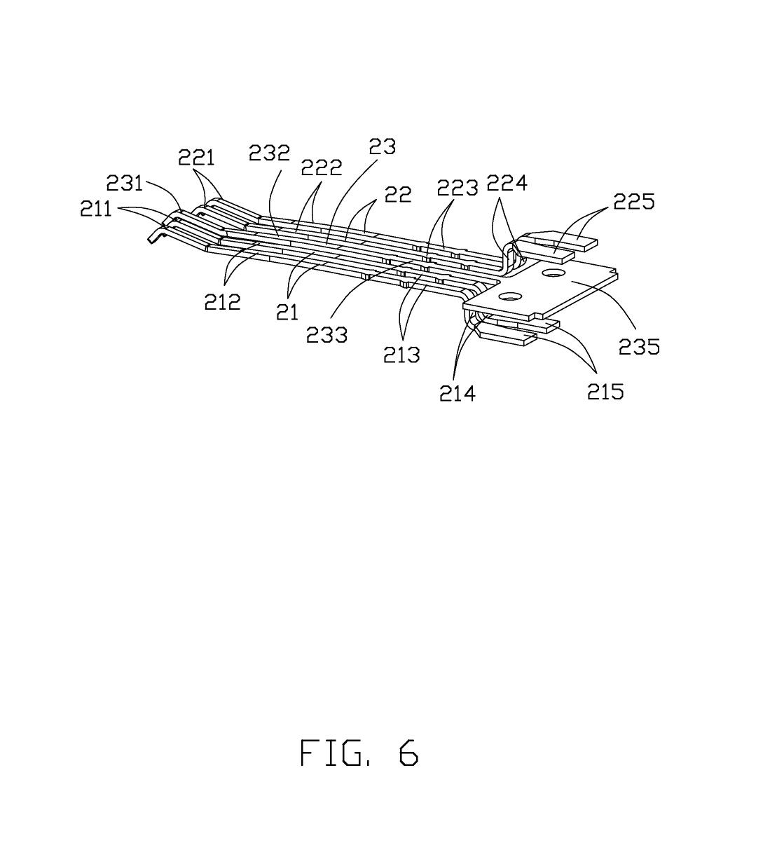

Referring to FIGS. 4-6, the contacts 2 include a pair of first contacts 21, a pair of second contacts 22 and a grounding contact 23. The grounding contact 23 is located between the first contacts 21 and the second contacts 22 to reduce the electronic magetic interference. The first contact 21 which is located in a right side of the second contact 22 includes a first retaining portion 213 retained in the retaining slot 103 of the body portion 10, a first extending portion 212 extending forwardly from the retaining portion 213, a contacting portion 211 extending forwardly from the extending portion 212, a first connecting portion 214 extending downwardly and vertically from the first retaining portion 213 and a soldering portion 215 extending backwardly and horizontally from the connecting portion 214. The first extending portion 212 is retained in the mating portion 11 and the first contacting portion 211 is retained in the receiving slot 112. The first soldering portion 215 is parallel with the first retaining portion 213, wider than the first retaining portion 213 and abuts against the first rib 1021 downwardly.

The second contact 22 includes a second retaining portion 223, a extending portion 222 extending forwardly from the second retaining portion 223, a second contacting portion 221 extending forwardly from the second retaining portion 223, a second connecting portion 224 extending upwardly and vertically from the second retaining portion 223 and a second soldering portion 225 extending backwardly and horizontally from the second connecting portion 224. The second extending portion 222 is retained in the mating portion 11 and the second contacting portion 221 is retained in the receiving slot 112. The second soldering portion 225 is parallel with the second retaining portion 223, and is wider than the second retaining portion 223. The second soldering portion 225 abuts against the second ribs 1022 upwardly. The first soldering portion 215 has a same width as that of the second soldering portion 225.

The grounding contact 23 includes a third retaining portion 233 retaining in the retaining slot 103 of the body portion 10, a third extending portion 232 extending forwardly from the third retaining portion 233, a third contacting portion 231 extending forwardly from the third extending portion 232 and a third soldering portion 235 extending backwardly and horizontally from the third retaining portion 233. The third soldering portion 235 is a horizontal board sharp which can cover the first soldering portion 215 and second soldering portion 225 along an up-to-down direction to separate the first soldering portion 215 from the second solder portion 225. The first soldering portions 215 are located below the second soldering 225. The third soldering portion 235 is located between the first and second ribs 1021, 1022 and abuts against the first and second ribs 1021, 1022.

The locking member 4 includes a retaining arm 41 retained in the mounting slot 104 of the body portion 10, a locking arm 42 extending forwardly from the retaining arm 41 and received in the through hole 113 of the mating portion 11 and a locking barb 421 extending upwardly from a front end of the locking arm 42. The locking barb 421 extends upwardly and out of the through hole 113.

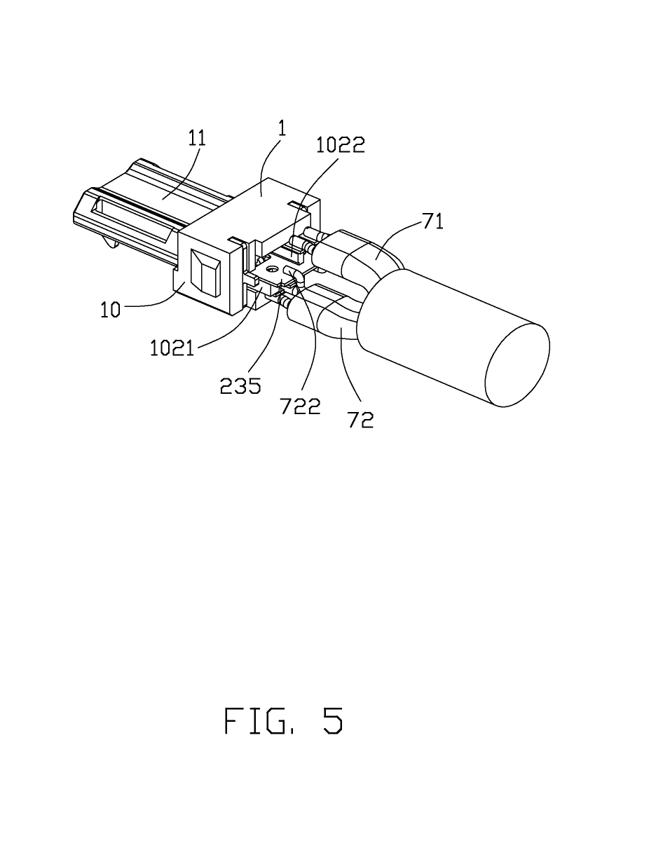

Referring to FIGS. 4-5, the cable 7 includes a first group 71 and a second group 72. The first group 71 includes two first wires 711 soldering with the first soldering portions 215, respectively, and a first grounding wire 712 soldering with the third soldering portion 235. The second group 72 includes two second wires 721 soldering with the second soldering portions 225, respectively, and a second grounding wire 722 soldering with the third soldering portion 235.

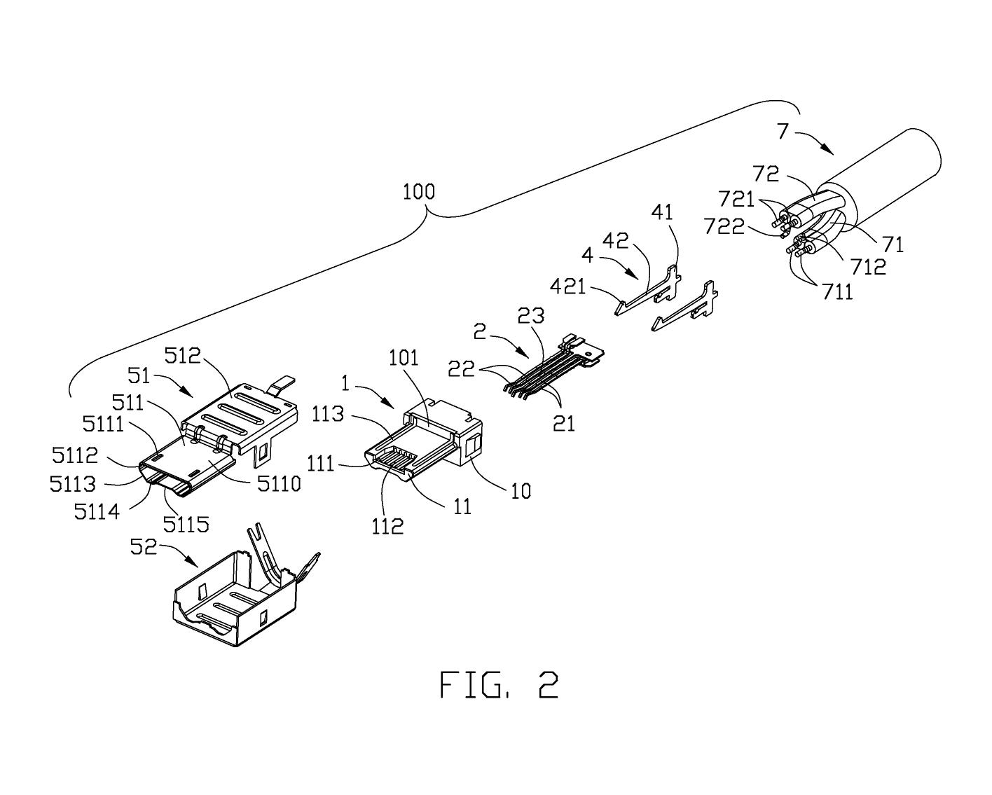

Referring to FIGS. 2-3, the metal shell 5 includes a top shell 51 and a bottom shell 52. The top shell 51 includes a receiving portion 511 and a fitting portion 512 extending backwardly from an end of receiving portion 511. The receiving portion 511 includes a top wall 5110, two first side walls 5112 extending downwardly from two sides of the top wall 5110, a bottom wall 5114 and two second side walls 5113 connecting two first side walls 5110 and the bottom wall 5114 aslantly to form a 45 angle. The bottom wall 5114 has a recessing slot 5115 depressed upwardly therefrom. The body portion 10 is received in the fitting portion 512. The mating portion 11 is received in the receiving portion 511. The receiving portion 511 has two openings 5111 passing therethrough upwardly for receiving the locking barb 421 of the locking member 4. The bottom shell 52 is assembled in the fitting portion 512 of the top shell 51 from a bottom side. The body portion 10 of the insulative housing 1 is located between the fitting portion 512 of the top shell 51 and the bottom shell 52.

The grounding contact 23 is located between the first and second contacts 21, 22. The third soldering portion 235 is a horizontal board sharp which separates the first soldering portion 215 from the second solder portion 225 along the up-to-down direction to improve signal transmission quality of the electrical connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having body portion; and
a plurality of contacts retained in the insulative housing, the contacts comprising a pair of first contacts, a pair of second contacts and a grounding contact located between the first and second contacts along an upper to lower direction, the first contact including a first retaining portion retained in the insulative housing and a first soldering portion located behind the first retaining portion, the second contact including a second retaining portion retained in the insulative housing and a second soldering portion located behind the second retaining portion, the grounding contact including a third retraining portion retained in the insulative housing and a third soldering portion extending backwardly from the third retaining portion, wherein the third soldering portion is in a horizontal board shape and overlaps with both the first soldering portion and the second soldering portion along the upper to lower direction.

2. The electrical connector as claimed in claim 1, wherein the first soldering portions are arranged in a row and the second soldering portions are arranged in another row, the third soldering portion is located between said two rows.

3. The electrical connector as claimed in claim 1, wherein the third soldering portion completely covers all of the first and second portions along the upper to lower direction.

4. The electrical connector as claimed in claim 1, wherein the first contact comprises a first connecting portion extending downwardly and vertically from the first retaining portion, the first soldering portion extends backwardly and horizontally from the first connecting portion, the first soldering portion is parallel with the first retaining portion.

5. The electrical connector as claimed in claim 1, wherein the second contact comprises a second connecting portion extending upwardly and vertically from the second retaining portion, the second soldering portion extends backwardly and horizontally from the second connecting portion, the second soldering portion is parallel with the second retaining portion.

6. The electrical connector as claimed in claim 1, wherein the insulative housing comprises a mating portion extending forwardly from the body portion, the insulative housing has an cutout depressed downwardly from a front of the mating portion, a plurality of receiving slots arranged in the cutout and passing through the mating portion backwardly, the first contact has a first extending portion extending forwardly from the retaining portion and a first contacting portion retained in the receiving slot, the second contact has a second extending portion extending forwardly from the retaining portion and a second contacting portion retained in the receiving slot, the grounding contact has a third extending portion extending forwardly from the third retaining portion and a third contacting portion retained in the receiving slot, the first, second and third contacting portions are located in the a row.

7. The electrical connector as claimed in claim 1, wherein the first soldering portion is wider than the first retaining portion, the second soldering portion is wider than the second retaining portion, the first soldering portion has a same width as that of the second soldering portion.

8. The electrical connector as claimed in claim 6, further comprising a metal shell covering the insulative housing, the metal shell includes a top shell having a receiving portion to receive the mating portion of the insulative housing, the receiving portion includes a top wall, two first side walls extending downwardly from the two sides of the top wall, a bottom wall and two second side walls connecting two first side walls and the bottom wall aslantly to form a 45 angle, the bottom wall has a recessing slot depressed upwardly therefrom.

9. The electrical connector as claimed in claim 1, further comprising a cable connecting with the contacts, the cable includes a first group having two first wires soldering with the first soldering portions and a first grounding wire soldering with the third soldering portion and a second group having two second wires soldering with the second soldering portions and a second grounding wire soldering with the third soldering portion.

10. An electrical connector comprising:
an insulative housing having a body portion and a mating portion extending forwardly from the body portion;
a plurality of contacts retained in the insulative housing, the contacts includes a plurality of first contacts and second contacts extending outside of the insulative housing and a grounding contact, the first contacts formed with first soldering portion arranged in a row, the second contacts formed with second soldering portion arranged in another row, the grounding contact having a third soldering portion which is located between the two rows of the first and second soldering portions along an upper to lower direction; and
a metal shell having a receiving portion to receive the mating portion of the insulative housing.

11. The electrical connector as claimed in claim 10, wherein the third soldering portion overlaps with the first and second portions along the upper to lower direction.

12. The electrical connector as claimed in claim 10, wherein the contacts comprise a pair of the first contacts, a pair of the second contacts, the second soldering portions stagger with the first soldering portion along a left-to-right direction.

13. The electrical connector as claimed in claim 10, wherein each of the first contacts has a first retaining portion retained in the insulative housing, each of the second contacts has a second retaining portion retained in the insulative housing, and the grounding portion has a third retaining portion, the first soldering portion is located behind the first retaining portion, the second soldering portion is located behind the second retaining portion, and the third soldering portion extends backwardly from the third retaining portion.

14. The electrical connector as claimed in claim 13, wherein the first contact comprises a first connecting portion extending downwardly and vertically from the first retaining portion, the first soldering portion extends backwardly and horizontally from the first connecting portion, the first soldering portion is parallel with the first retaining portion, the second contact comprises a second connecting portion extending upwardly and vertically from the second retaining portion, the second soldering portion extends backwardly and horizontally from the second connecting portion, and the second soldering portion is parallel with the second retaining portion.

15. The electrical connector as claimed in claim 13, wherein the first soldering portion is wider than the first retaining portion, the second soldering portion is wider than the second retaining portion, the first soldering portion has a same width as that of the second soldering portion.

16. An electrical cable connector assembly comprising:
an insulative housing defining a front mating port and a rear connecting port;
a plurality of contacts disposed in the housing and categorized with at least two pairs of differential pair and one grounding contact sandwiched between said two pairs of differential pair, each of the contacts defining a front mating section and a rear connecting section; wherein]
the front mating sections of said contacts are arranged in one row in a transverse plane while the connecting sections of said contacts are arranged with upper, middle and lower rows spaced from one another in a vertical direction perpendicular to said transverse plane under condition the connecting sections of said two pairs of differential pair are respectively located in the upper row and the lower row, and the connecting section of the grounding contact is located in the middle row.

17. The electrical cable connector assembly as claimed in claim 16, wherein the connecting sections of one pair of the different pair is offset from those of the other pair in the transverse direction

18. The electrical cable connector assembly as claimed in claim 17, wherein the connecting section of the grounding contact is spanned to overlap with the two pairs of different pair in a vertical direction.

19. The electrical cable connector assembly as claimed in claim 18, further including a pair of spacers respectively separating the connecting sections of each different pair and that of the grounding contact.

20. The electrical cable connector assembly as claimed in claim 18, further including a pair of cables each including a pair of signal wires and a grounding wire wherein the signal wires are electrically and mechanically connected to the corresponding different pair, respectively, and the grounding wire is electrically and mechanically connected to the connecting section of the grounding contact at a position aligned with the corresponding connecting sections in the vertical direction.
